(19) United States
(12) Patent Application Publication
(10) Pub. No.: US 2009/0101696 A1
(43) Pub. Date: Apr. 23, 2009

(54) Attachable rigid bottom with hinge for file folder

(76) Inventor: Bon S. Ong, Torrance, CA (US)

Correspondence Address: Cislo & Thomas LLP, 1333 2nd Street, Suite #500, Santa Monica, CA, 90401-4110, US

(21) Appl. No.: 11/975,497

(22) Filed: Oct. 19, 2007

(51) Int. Cl. B42F 7/04; B31B 49/00

(52) U.S. Cl. 229/67.1; 281/45; 493/379

(57) ABSTRACT

A file folder with a rigid bottom piece attached to the inside of the file folder with a hinge is contemplated. The file folder may be a hanging file folder. The file folder may also have open side ends or closed side ends that are closed in with side walls. The rigid bottom piece is uniquely affixed with a hinge attachment and is useful in creating a stable file folder that maintains its shape when filled with documents, items, or other materials.

### TECHNICAL FIELD

This invention relates to office supplies and in particular, organizational supplies such as file folders with a moveable rigid bottom attached with a hinge that can be positioned in the file folder to assist in keeping materials stored and filed in an orderly and neat manner.

### BACKGROUND ART

In many professional fields and other endeavors that utilize document storage management techniques, well-structured storage file folders are essential. Current storage mechanisms of documents or other important items include filing the items in folded file folders or folded hanging file folders. Such file folders or hanging file folders are wide enough to hold a few sheets of paper or narrow non-document items. However, filing and storing a large number of sheets or wider items overloads current designs thereby decreasing file mobility in a file cabinet or other storage device, degrading the quality of the file, and obscuring any code or marking on the file.

Additionally, many current files have vertical sides that are open. If the file is removed and carried away from a file cabinet or if the file contains an object; for example, evidence or product samples, it may be more advantageous to have a file with closed vertical sides to prevent documents or objects from easily slipping out of the file.

Accordingly, there is a need in the art for file folders that are well-structured and capable of securely and neatly holding several documents or non-document items at a time.

### DISCLOSURE OF INVENTION

The present invention relates to a file folder comprising a front wall attached to a back wall with a bottom wall so as to create an inside of the file folder and an outside of the file folder, the bottom wall having a rigid bottom piece attached to its edge on the inside of the folder with a hinge; wherein the rigid bottom piece can be removably or fixedly placed to flatten out the bottom wall. The bottom wall may have one or more pleats. Furthermore, the file folder may be a hanging file folder and may further comprise adjustable hanging hooks and inner or outer storage pockets on the front and back walls.

In another inventive embodiment, the present invention relates to a hanging file folder comprising a front wall attached to a back wall with a bottom wall, the bottom wall having a rigid bottom piece attached to its edge on the inside of the folder with a hinge, and two vertical side walls attached to the vertical edges of the front and back walls so as to create an inside of the file folder and an outside of the file folder; wherein the rigid bottom piece can be removably or fixedly placed to flatten out and support the bottom. The bottom wall and the side walls may have one or more pleats. The file folder may further comprise a hanging file folder or may have adjustable hanging hooks and/or inner or outer storage pockets on the front and back walls.

Methods of reinforcing the file folder are contemplated comprising placing the rigid plastic bottom piece of the file folder over the bottom wall. Additional methods contemplated include using the file folder to store documents or non-document items.

### BRIEF DESCRIPTION OF DRAWINGS

FIG. 1 is a perspective view of an embodiment of a file folder with an attachable rigid bottom piece attached to the file folder with a hinge.

FIG. 2 is a side view of an embodiment of a file folder with an attachable rigid bottom piece attached to the file folder with a hinge where the rigid bottom piece is in the up position.

FIG. 3 is a side view of an embodiment of a file folder with an attachable rigid bottom piece attached to the file folder with a hinge where the rigid bottom piece is in the down position.

FIG. 4 is a side view of an embodiment of a file folder with an attachable rigid bottom piece attached to the file folder with a hinge where the file folder is in an open, unfolded position.

FIG. 5 is a top view of an embodiment of a file folder with an attachable rigid bottom piece attached to the file folder with a hinge where the rigid bottom piece is in the up position.

FIG. 6 is a top view of an embodiment of a file folder with an attachable rigid bottom piece attached to the file folder with a hinge where the rigid bottom piece is in the down position.

FIG. 7 is a perspective view of one embodiment of the invention showing the rigid bottom piece in dashed lines in the up position.

FIG. 8 is a perspective view of one embodiment of the invention showing the rigid bottom piece in dashed lines in the down position.

### BEST MODE FOR CARRYING OUT THE INVENTION

The detailed description set forth below in connection with the appended drawings is intended as a description of exemplary embodiments and is not intended to represent the only forms in which these embodiments may be constructed and/or utilized. The description sets forth the functions and the sequence of steps for constructing and operating the exemplary embodiments. However, it is to be understood that the same or equivalent functions and sequences may be accomplished by different embodiments that are also intended to be encompassed within the spirit and scope of the specification.

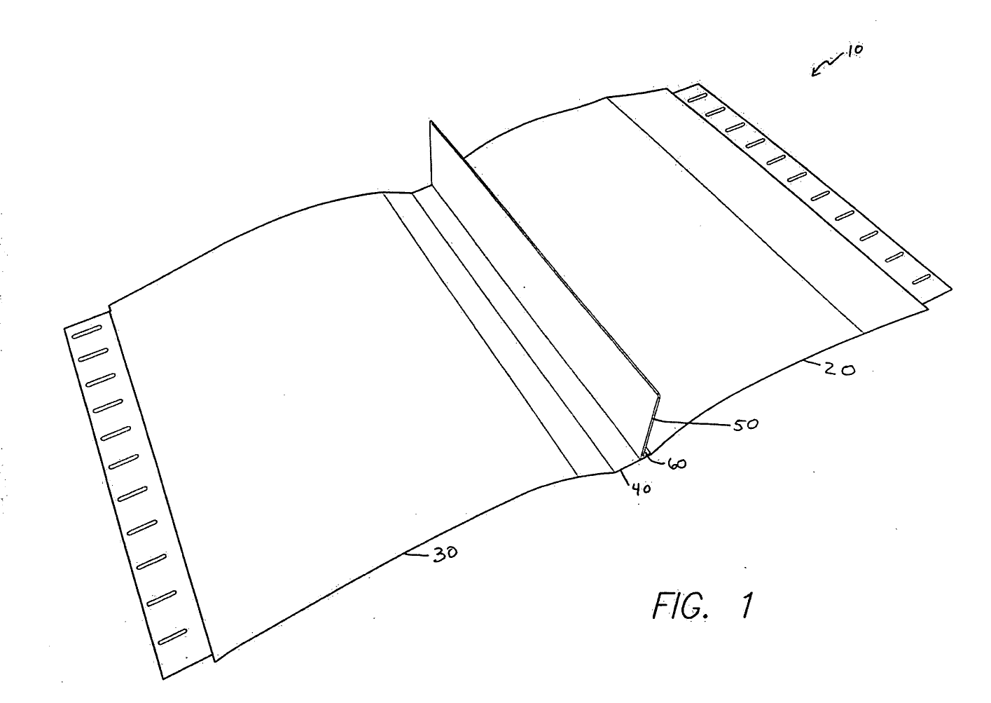

File folders with an attachable rigid bottom piece attached to the file folder with a hinge are contemplated. In one embodiment as shown in FIG. 1, the file folder 10 comprises a front wall 20 attached to a back wall 30 with a pleated bottom wall 40, the pleated bottom wall having a rigid bottom piece 50 attached to the edge of the pleated bottom wall 40 on the inside of the folder with a hinge 60; wherein the rigid bottom 50 can be removably or fixedly placed to flatten out the pleated bottom 40. The rigid bottom piece 50 may be attached to the inner edge of the pleated bottom wall 40 with a hinge 60 that is fastened to the rigid bottom piece 50 and the inner edge of the pleated bottom wall 40 by a fastening mechanism selected from the group consisting of a weld, adhesive, glue, staples, other fastening mechanisms, and combinations thereof. The weld may include a heat or pressure weld whereby the materials of the hinge 60 and the rigid bottom piece 50 and the inner edge of the pleated bottom wall 40 are fused together by using heat and/or pressure optionally with a material having a high melting point. The file folder may further comprise hanging hooks along the top edge of the front and back walls, and inner or outer storage pockets on the front and back walls. Suitable materials for the file folder may be selected from the group consisting of plastic, paper, a sturdy and flexible material, and combinations thereof.

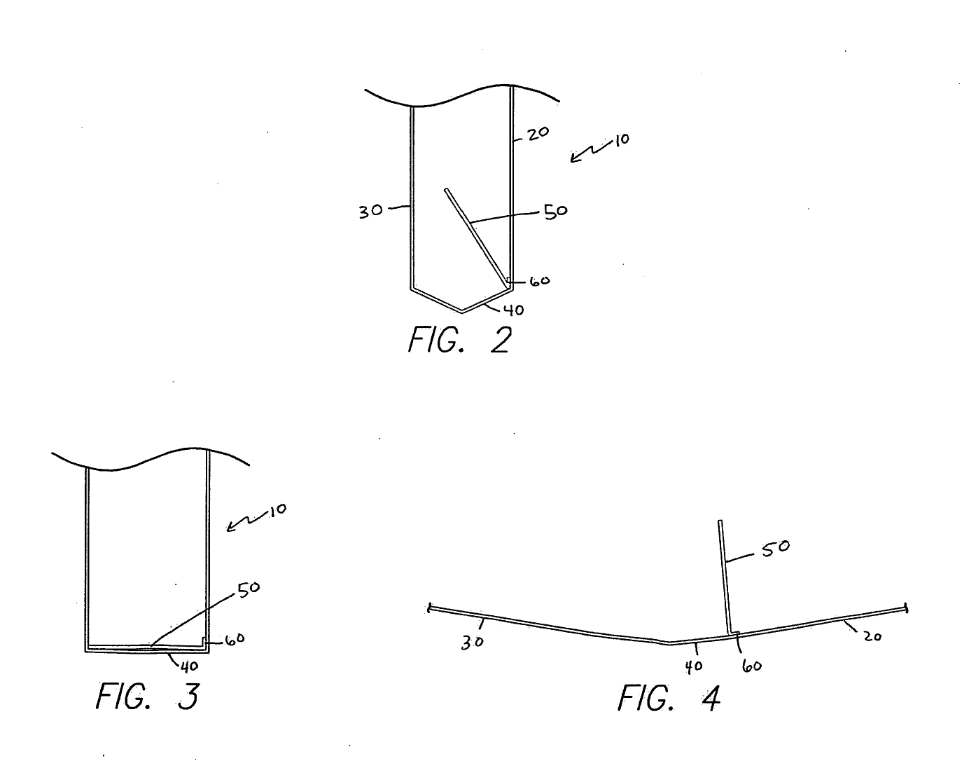

In FIG. 2, a side view of one embodiment of the invention is shown with the rigid bottom piece 50 attached on the inside of the file folder 10 with a hinge 60. The hinge 60 may be attached at the edge of the pleated bottom wall 40 and the front wall 20 as shown or at the edge of the pleated bottom wall 40 and the back wall 30. The hinge 60 may be fastened by a weld, adhesive, glue, staples, other fastening means, and combinations thereof. The rigid bottom piece 50 is shown in the up position.

In FIG. 3, a side view of one embodiment of the invention is shown with the rigid bottom piece 50 in the down position to flatten out the bottom of the file folder 10 and to create a stable structure of the file folder 10. The rigid bottom piece 50 is attached to the file folder with a hinge 60. As shown, the pleated bottom wall 40 is flattened by the support of the rigid bottom piece 50. Although it is not necessary that the bottom wall 40 be pleated, pleating is preferred since it facilitates expansion and flattening of the file folder 10.

In FIG. 4, a side view of an embodiment of a file folder 10 having a front wall 20 and a back wall 30, a bottom wall 40, and an attachable rigid bottom 50 is shown with the file folder 10 in an open, unfolded position. The attachable rigid bottom 50 is attached to the file folder 10 with a hinge 60. The front wall 20 and a back wall 30 may be interchangeable.

In all of the aforementioned embodiments, the bottom wall may have no pleats or may have one or more pleats.

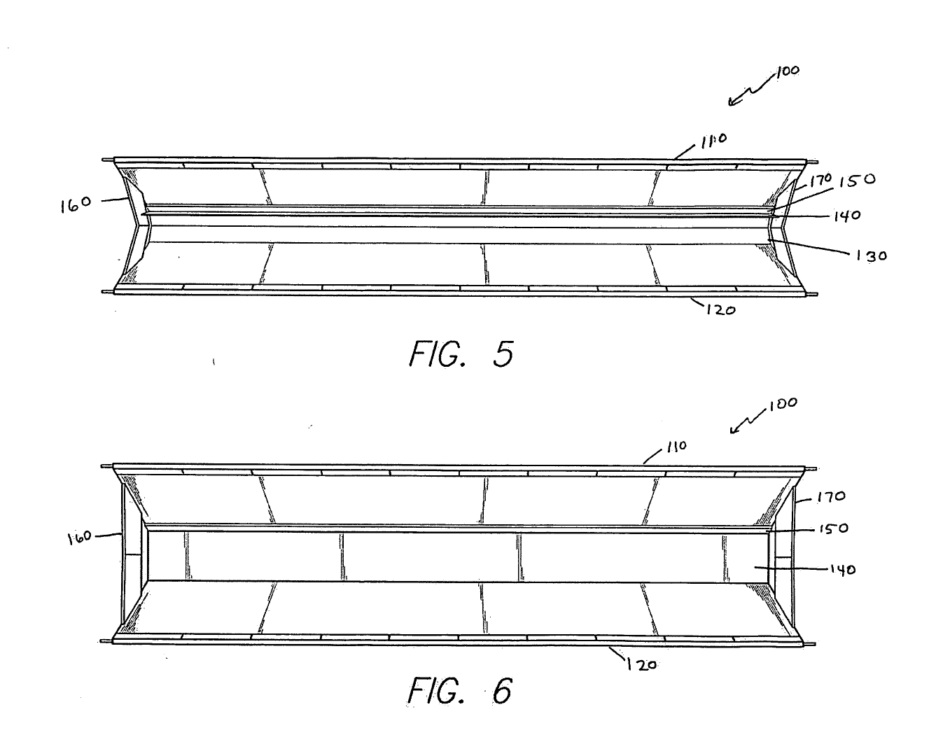

In another inventive embodiment as shown in FIGS. 5-8, the file folder 100 comprises a front wall 110 attached to a back wall 120 with a pleated bottom wall 130, the pleated bottom wall 130 having a rigid bottom piece 140 attached to the edge of the pleated bottom wall 130 on the inside of the folder with a hinge 150; and two pleated vertical side walls, a first pleated side wall 160 and a second pleated side wall 170, attached to the vertical edges of the front 110 and back walls 120; wherein the rigid bottom piece 140 can be removably or fixedly placed to flatten out the pleated bottom 130. The rigid bottom piece 140 may be attached to the inner edge of the pleated bottom wall 130 with a hinge 150 that is fastened to the rigid bottom piece 140 and the inner edge of the pleated bottom wall 130 by a fastening mechanism selected from the group consisting of a weld, adhesive, glue, staples, other fastening mechanisms, and combinations thereof. The weld may include a heat or pressure weld resulting from using heat and/or pressure to fuse the materials of the hinge 150 and the rigid bottom piece 140 and the inner edge of the pleated bottom wall 130 together. A material having a high melting point may also be used to achieve the weld. The front wall 110 and a back wall 120 and a first pleated side wall 160 and a second pleated side wall 170 may be interchangeable.

In FIG. 6, a top view of one embodiment of the invention is shown 100, wherein the front wall 110 and the back wall 120 are attached on the bottom by a pleated bottom wall that is obscured by a rigid bottom piece 140. The rigid bottom piece 140 is attached by a hinge 150 which is fastened to the front 110 or back wall 120. When the rigid bottom piece 140 is positioned flat in the bottom of the file folder 100, the pleated side walls 160 and 170 stretch out and become entirely or partially flat.

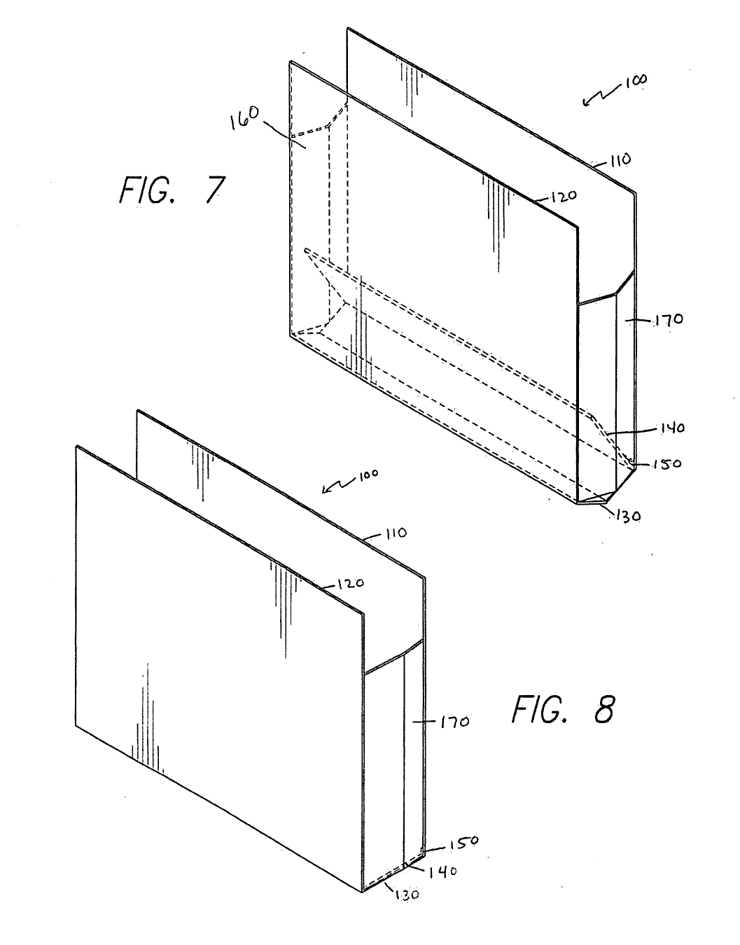

In FIG. 7, a side perspective view of the file folder 100 is shown having a front wall 110 and a back wall 120 with pleated side walls, one pleated side wall 170 is showing in unbroken lines and a second pleated side wall 160 is shown in dashed lines. Also shown in dashed lines is the rigid bottom piece 140 in an up position and its hinge 150 attachment to the edge of the front wall 110 and the pleated bottom wall 130.

In FIG. 8, a side perspective view of the file folder 100 is shown where the rigid bottom piece 140, shown in dashed lines, is pushed down so as to flatten out the pleated bottom wall 130 and create a firm base for the folder. One pleated side wall 170 is shown attached to the front wall 110 and the back wall 120.

In all of the aforementioned embodiments, the bottom wall and the side walls may have no pleats or may have one or more pleats.

The file folder may further comprise hanging hooks along the top edge of the front and back walls, and inner or outer storage pockets on the front and back walls. Suitable materials for the file folder include material selected from the group consisting of plastic, paper, a sturdy and flexible material, and combinations thereof.

The file folder may be of a size capable of holding legal size paper, 8.5 by 14 inches, or letter size paper, 8.5 by 11 inches. In a preferred embodiment, the front and back walls are equal in size and are 7 to 10 inches high and 10 to 17 inches long. The bottom wall may have no pleats or may have one or more pleats and may be of varying widths and lengths. The bottom wall is preferably 0.5 to 5 inches wide and equal in length to the length of the front and back walls, that is, 10 to 17 inches long. The rigid bottom piece has a width and length equal to the bottom wall. The side walls have no pleats or one or more pleats and may be of varying widths and height. The side walls are is preferably 0.5 to 5 inches wide and between 4 to 10 inches high.

Methods of using the file folder to store documents or non-document items are also contemplated. Methods of reinforcing the file folder by placing the rigid bottom piece over the bottom wall are also contemplated. The rigid bottom piece may be removably or fixedly placed over the bottom wall.

While the present invention has been described with regards to particular embodiments, it is recognized that additional variations of the present invention be devised without departing from the inventive concept.

### INDUSTRIAL APPLICABILITY

This invention may be industrially applied to the development, manufacture, and use of record keeping, organizational management, or the like, and may be useful in all industries, areas, and professions where such industrial uses are applied.

What is claimed is:

1. A file folder comprising
a front wall attached to a back wall with a bottom wall so as to create an inside of the file folder and an outside of the file folder, and a rigid bottom piece attached with a hinge to an edge of the bottom wall on the inside of the file folder, the hinge fastened to the inside of the file folder by a fastening mechanism selected from the group consisting of a weld, adhesive, glue, staples, and combinations thereof;
wherein the rigid bottom piece can be removably placed to flatten out the bottom wall, and the front wall and the back wall both have dimensions of between 7 to 10 inches high and 10 to 17 inches long, and the bottom wall and the rigid bottom piece both have dimensions between 0.5 to 5 inches wide and 10 to 17 inches long.

2. A file folder of claim 1, further comprising two side walls, each of which are attached to the front wall and the back wall.

3. A file folder of claim 1, wherein the file folder is made of a material selected from the group consisting of plastic, paper, and combinations thereof.

4. The file folder of claim 1, wherein the bottom wall has one or more pleats.

5. A file folder comprising
a front wall attached to a back wall with a bottom wall so as to create an inside of the file folder and an outside of the file folder, and a rigid bottom piece attached with a hinge to an edge of the bottom wall on the inside of the file folder;
wherein the rigid bottom piece can be placed to flatten out the pleated bottom wall.

6. The file folder of claim 5, wherein the hinge is fastened to the inside of the file folder by a fastening mechanism selected from the group consisting of a weld, adhesive, glue, staples, and combinations thereof.

7. The file folder of claim 6, wherein the bottom wall has one or more pleats.

8. The file folder of claim 5, wherein the file folder is made of a material selected from the group consisting of plastic, paper, and combinations thereof.

9. The file folder of claim 5, wherein the front wall and the back wall are between 7 to 10 inches high and 10 to 17 inches long.

10. The file folder of claim 5, wherein the bottom wall and the rigid bottom piece are between 0.5 to 5 inches wide and 10 to 17 inches long.

11. A file folder comprising
a front wall attached to a back wall with a bottom wall and two side walls so as to create an inside of the file folder and an outside of the file folder, a rigid bottom piece attached with a hinge to an edge of the bottom wall on the inside of the file folder;
wherein the rigid bottom piece can be placed to flatten out the bottom wall.

12. The file folder of claim 11, wherein the hinge is fastened to the inside of the file folder by a fastening mechanism selected from the group consisting of a weld, adhesive, glue, staples, and combinations thereof.

13. The file folder of claim 12, wherein the bottom wall and the side walls have one or more pleats.

14. The file folder of claim 11, wherein the file folder is made of a material selected from the group consisting of plastic, paper, and combinations thereof.

15. The file folder of claim 11, wherein the front wall and the back wall are between 7 to 10 inches high and 10 to 17 inches long.

16. The file folder of claim 11, wherein the bottom wall and the rigid bottom piece are between 0.5 to 5 inches wide and 10 to 17 inches long.

17. The file folder of claim 7, wherein the side walls are between 0.5 and 5 inches wide and 4 to 10 inches high.

18. A method of reinforcing the file folder of claim 1 comprising placing the rigid bottom piece over the bottom wall.

19. A method of reinforcing the file folder of claim 5 comprising placing the rigid bottom piece over the bottom wall.

20. A method of reinforcing the file folder of claim 11 comprising placing the rigid bottom piece over the bottom wall.
